(19) United States
(12) Patent Application Publication
(10) Pub. No.: US 2013/0078045 A1
(43) Pub. Date: Mar. 28, 2013

(54) DRILL HEAD FOR A DEEP HOLE DRILLING TOOL FOR BTA DEEP HOLE DRILLING, AND DEEP HOLE DRILLING TOOL

(71) Applicants: Hermann Randecker, Dettingen (DE); Andreas Bernt, Neuffen-Kappishausern (DE)

(72) Inventors: Hermann Randecker, Dettingen (DE); Andreas Bernt, Neuffen-Kappishausern (DE)

(21) Appl. No.: 13/642,813

(22) PCT Filed: Apr. 15, 2011
(86) PCT No.: PCT/EP2011/055987

§ 371 Date: Dec. 11, 2012

(30) Foreign Application Priority Data
Apr. 23, 2010 (DE) 10 2010 018 959.6

(51) Int. Cl. B23B 51/06; B23B 51/00

(52) U.S. Cl. CPC B23B 51/06; B23B 51/0054
USPC 408/57

(57) ABSTRACT

A drill head for a deep hole drilling tool. A drill head body is rotatable about an axis of rotation and has a drilling side and a cavity duct with a chip collecting orifice. A cutting edge has a main and a secondary cutting edge cant, the secondary cutting edge cant arranged on a radial outside of the cutting edge. The main and the secondary cutting edge cants form a cutting edge corner and span a rake which is arranged contiguously to the chip collecting orifice. A first guide pad is arranged in a circumferential half, facing away from the rake, and a second guide pad is arranged diametrically opposite the cutting edge corner. The first guide pad can be offset to the cutting edge corner by the amount of a guide pad angle in the circumferential direction of the drill head The guide pad angle amounts to less than 70°.

### BACKGROUND OF THE INVENTION

The invention relates to a drill head for a deep hole drilling tool for BTA/STS or ejector deep hole drilling according to the precharacterizing clause of claim 1 and to a deep hole drilling tool according to the precharacterizing clause of claim 12.

Deep hole drilling is a special drilling method which is employed above all for making boreholes with a diameter of 1 mm to 1500 mm to a depth of more than three times the diameter, while even very deep boreholes with a depth/diameter ratio greater than 200 can be made. A deep hole drilling tool is usually composed of a drill shank which is also designated in the case of deep hole drilling tools as a drill tube and acts as an extension piece and of a drill head which is attached to the front end of the drill shank and on which one or more cutting edges are arranged.

What is characteristic of deep hole drilling is a continuous supply of cooling lubricant under pressure and continuous chip discharge without chip-removing strokes. This means that even deep boreholes can be made in one pass by means of the deep hole drilling method, and the drill does not have to be extracted from the borehole in the meantime for the removal of chips. A distinction is made essentially between three deep hole drilling methods, to be precise single-lip deep hole drilling, not involved any further in this application, BTA deep hole drilling which is also designated as STS (“Single Tube System”), and ejector deep hole drilling which is also known as deep hole drilling with a dual-tube system. These methods differ from one another in the deep hole drilling tools used, in the flow of cooling lubricant and in the chip flow.

In BTA or STS deep hole drilling, the supply of cooling lubricant takes place from outside via a special cooling lubricant supply device. In this case, the cooling lubricant is conveyed under pressure into an annular space between the outside of the drilling tool and the inner wall of the borehole. Cooling lubricant and chip return take place through a cavity duct provided inside the deep hole drilling tool.

Ejector deep hole drilling is a variant of BTA deep hole drilling. In the ejector deep hole drilling, a drill tube with two concentrically arranged tubes, an outer tube and an inner tube, is used. The supply of cooling lubricant takes place by means of a cooling lubricant supply device into an annular space between the outer tube and the inner tube. The cooling lubricant flows along the drill tube in the annular space and first emerges in the borehole, at the front of the drill head, laterally outward and washes around the drill head from outside. The cooling lubricant subsequently flows back together with the chips, specifically in the inner tube which forms the cavity duct.

For BTA deep hole drilling, special deep hole drilling tools are required which differ significantly in their set-up from a conventional drilling tool, such as, for example, a twist drill, but also from single-lip deep hole drilling tools.

BTA deep hole drilling tools have a drill head with a drill head body which is rotatable about an axis of rotation and which has at its one end a drilling region with a drilling side. A cavity duct for chip and cooling lubricant return is provided inside and leads to a corresponding duct in the drill tube. One or more cutting edges arranged asymmetrically to the axis of rotation are provided on the drilling side of the drill head body.

The cutting edge is in this case the part of the drilling tool which is first to penetrate into the workpiece to be machined and which generates a mechanical separating action. Both exchangeable cutting edges, which are usually clamped or screwed to the drill head body for fastening, and cutting edges firmly connected to the drill head body are known. Particularly in the case of small drill head diameters, the cutting edge inserts are fastened by soldering. The cutting edge has a wedge-shaped design and forms a cutting wedge for generating high pressure forces from the forces introduced and normally has a main cutting edge and a secondary cutting edge. In this case, the main cutting edge is that part of the cutting edge on which the greatest proportion of the cutting work is performed. The region where the main and the secondary cutting edge meet is designated as a cutting edge corner which in practice is provided with a radius. The main cutting edge and secondary cutting edge or their cants span a rake, the rake being the face on which the chip which has occurred as a result of a relative movement between the tool and the workpiece slides off. That cant of the cutting edge at which the rake and the flank are contiguous to one another is designated as the cutting edge cant.

During drilling, machining takes place by means of a circular cutting movement, that is to say a circular relative movement between the tool and workpiece, a feed movement in the direction of the axis of rotation occurring. The cutting edges in BTA deep hole drilling tools are in each case arranged with their rake contiguous to a chip collecting orifice. The chips are collected in this orifice and, together with the cooling lubricant, are conveyed from this orifice to the cavity duct inside and are returned or discharged through this.

Deep hole drilling tools are designed for self-guidance in the borehole. For this purpose, they have guide pads or supporting strips which are arranged in the drilling region, on the outside of the drill head body, parallel to the axis of rotation and in each case have an outer bearing zone. The outer bearing zones of the guide pads, which are also designated as contact zones, are provided for bearing against the inner wall of the borehole and, together with the secondary cutting edge or at least a part of the secondary cutting edge which is foremost in a feed direction, ensure that the drill head is guided in the borehole.

The known drill heads have secondary cutting edges and guide pads with a special ground portion, by means of which the frictional forces between the secondary cutting edge or the guide pads and the inner wall of the borehole are to be minimized. The secondary cutting edge has, in a region contiguous to the secondary cutting edge cant, what is known as a circular-ground chamfer which is ground down with a smaller radius than the borehole radius. The circular-ground chamfer and/or the guide pads may also have a ground relief, so that they guide the drill head solely in its front region and, from the drilling side, are inwardly formed conically, opposite to the feed direction. If two guide pads are present, three-point bearing contact is obtained from these and from the circular-ground chamfer.

BTA deep hole drilling heads known from the prior art have two or more guide pads or further supporting and/or auxiliary strips. In this case, one of the guide pads is designed for absorbing forces acting tangentially upon the cutting edge. This guide pad is usually designated as the first guide pad. It is normally arranged, offset to the cutting edge corner by the amount of a guide pad angle of approximately 85° to 90°, measured from the cutting edge corner in the circumferential direction, in a circumferential half of the drill head body which faces away from the rake. Another guide pad is arranged diametrically from the cutting edge corner for the purpose of absorbing forces acting radially upon the cutting edge. This is designated as the second guide pad.

By means of the abovementioned BTA deep hole drilling method, the most diverse possible borehole geometries can be made in the most different possible materials. It became apparent, however, that the known BTA deep hole drilling tools or the drill heads of these BTA deep hole drilling tools do not have sufficient tool lives and/or do not deliver sufficient borehole quality during the machining of some materials, as compared to other materials. In particular, the circular-ground chamfer on the secondary cutting edge, which chamfer forms with the two guide pads the three-point bearing contact, is severely loaded during the BTA deep hole drilling of these materials, and therefore the cutting edge has to be exchanged at an early stage, this having an adverse effect upon costs. Short tool lives signify frequent tool change and therefore increased tool investment and productivity losses. Moreover, it was shown that, in the machining of some materials, the known BTA deep hole drilling tools tend to oscillate during the deep hole drilling operation, and this may likewise have an adverse effect upon borehole quality.

### OBJECT AND SOLUTION

An object of the invention is to provide a generic BTA/STS or ejector deep hole drilling head which makes it possible to have a high tool life during the machining of the most diverse possible materials and which tends to a lesser extent to oscillate during the drilling operation. Furthermore, an object of the invention is to provide a corresponding BTA deep hole drilling tool.

To achieve this and other objects, the invention provides a drill head for a deep hole drilling tool for BTA/STS or ejector deep hole drilling, having the features of claim 1, and a deep hole drilling tool having the features of claim 12. Advantageous developments are specified in the dependent claims. The wording of all the claims becomes the content of the description by reference.

A drill head according to the invention is characterized in that the guide pad angle, by the amount of which the first guide pad is arranged so as to be offset to the cutting edge corner in the circumferential direction, amounts to less than 70°. A deep hole drilling tool with a drill head and with a drill tube according to the invention is characterized by an abovementioned drill head according to the invention.

The guide pad angle is in this case the angle which is meeasured in the circumferential direction of the drill head and which is formed by a first straight line running radially through the cutting edge corner and the axis of rotation and a second straight line likewise running radially through the axis of rotation, the second straight line running orthogonally to a tangent which has its contact point at the theoretical bearing point of the outer bearing zone of the first guide pad against the inner wall of the borehole.

During the machining operation, different forces and moments act upon the cutting edge and therefore upon the drill head. The forces of greatest amount are, on the one hand, machining forces at the cutting edge and frictional forces which occur particularly at the guide pads and circular-ground chamfer. The machining force is the force which acts upon the cutting edge or the cutting wedge. It is composed of a cutting force (in the cutting direction) and of a feed force (in the feed direction), these forces acting perpendicularly to one another. The cutting force in this case is dependent, inter alia, on the material to be machined and on the cutting edge geometry. A passive force acts perpendicularly to the resultant of the cutting force and of the feed force. The passive force is determined essentially by the lead angle of the cutting edge in the feed direction. The passive force does not contribute to the occurrence of chips, but instead forces the tool out of the material.

Detailed investigations showed that, in BTA deep hole drilling tools from the prior art, because of the asymmetric arrangement of the cutting edge and because of its main cutting edge cant running, on the one hand, radially and, on the other hand, in the feed direction, usually with a lead angle, a moment about the first guide pad is generated by the cutting force about an axis parallel to the axis of rotation. This moment leads to tilting or turning of the drilling tool or of the front part of the drill head about the first guide pad, and a radially inward-action passive force of appreciable amount arises as supporting force at the secondary cutting edge or circular-ground chamfer, because the drill head is pressed with the secondary cutting edge or circular-ground chamfer against the inner wall of the borehole. The higher the passive force is at the secondary cutting edge or circular-ground chamfer, the higher is the frictional force between the secondary cutting edge or circular-ground chamfer and the inner wall of the borehole and therefore the wear on the secondary cutting edge or circular-ground chamfer.

If the guide pad angle is reduced to an angle smaller than 70°, the effective lever arm with which the cutting force generates a moment about the first guide pad is reduced. A reduced tilting moment leads correspondingly to reduced supporting forces and therefore to diminished friction in the region of the secondary cutting edge cant, this having an especially advantageously effect upon the tool life of the cutting edge.

Moreover, it became apparent, that owing to the markedly reduced passive force in the region of the secondary cutting edge, the tendency to oscillate during the drilling operation can be reduced, thus leading in these cases to markedly improved borehole quality.

The second guide pad is arranged diametrically to the cutting edge corner. The term “diametrical” means in this application that the corresponding circumferential angle to the cutting edge cant amounts to about 180°. Minor deviations in the range of ±10° to ±15° from the 180° arrangement are also likewise designated here as “diametrical”.

In a preferred refinement of the invention, the guide pad angle, by the amount of which the first guide pad is arranged so as to be offset to the cutting edge corner in the circumferential direction, amounts of 30° to 70°. Preferably, this angle amounts of 40° to 60°, in particular 45° to 55°. It proves especially advantageous for most materials if the first guide pad is arranged in this angular range, since, for most materials, the effective lever arm is already markedly reduced and improved borehole quality can be achieved.

In a preferred refinement of the invention, the guide pad angle is selected for defined drilling parameters such that, in the case of a cutting force acting perpendicularly upon the rake on the main cutting edge cant during the drilling process, a passive force acting upon the secondary cutting edge in the radial direction becomes approximately zero for the defined drilling parameters. The secondary cutting edge is scarcely still loaded radially, thus leading to a further improvement in the tool life, as compared with an already reduced passive force. The tendency to oscillate during the drilling operation can likewise be reduced to a minimum by a correspondingly selected guide pad angle, thus leading to a yet more markedly improved borehole quality.

If the guide pad angle is selected according to the required defined drilling parameters such that the passive force which acts upon the secondary cutting edge in the radial direction becomes approximately or completely zero, this means that the frictional forces at the secondary cutting edge likewise become approximately zero. The circular-ground chamfer may, in particular, in this case also be useful as oscillation damping.

If appropriate, a circular-ground chamfer may be dispensed with entirely. In a development of the invention, the secondary cutting edge of the drill head has no circular-ground chamfer. This is extremely advantageous because the special grinding down or grinding of the special contour of the circular-ground chamfer entails a high and cost-intensive outlay in manufacturing terms which can thus be avoided. For oscillation damping, one or more further guide pads may be provided, in which case preferably one further guide pad is arranged in a circumferential direction in approximately the same radial position as the cutting edge corner, but behind the cutting edge corner in the feed direction.

Drill heads are known from the prior art in which a radially outwardly or inwardly adjustable cutting edge is provided. The flight circle diameter of the drill head or the centre point position of the flight circle can thereby be modified, as required. The flight circle is in this case the circle which defines a resulting cutting contour or corresponds to this. When the centre point of the flight circle and the axis of rotation coincide, the flight circle also corresponds to a drill head nominal diameter. The disadvantage of an adjustable cutting edge, however, is that the fit of the cutting edge is usually less stable than in the case of a cutting edge of non-adjustable design. Furthermore, the outlay in manufacturing terms for an adjustable cutting edge fit is markedly higher and therefore more cost-intensive than for a fixed, radially non-adjustable cutting edge fit.

By contrast, in some embodiments, there is provision whereby for at least one of the guide pads, in particular for the second guide pad, a radial spacing between its outer bearing zone and the axis of rotation can be set. Since lower forces act upon the second guide pad than upon the cutting edge, it is especially advantageous to bring about a variation in the flight circle diameter or a modified centre point position of the flight circle by varying the radial spacing between the outer bearing zone of the second guide pad and the axis of rotation, not by modifying the radial spacing between the cutting edge corner and the axis of rotation. If the spacing between the second guide pad and the axis of rotation is modified, the flight circle defined by the two guide pads and the cutting edge corner changes.

If there is a possibility of adjustment via the radial adjustment of a guide pad, the cutting edge can be accommodated in a firm fit. In a preferred embodiment of the invention, the cutting edge is arranged in a firm fit, so that the radial spacing from the cutting edge corner is radially non-adjustable.

Preferably, the cutting edge is arranged in a firm fit and a radial spacing between its outer bearing zone and the axis of rotation can be set only for the second guide pad. As a result, with the cutting edge and the first guide pad being in a firm fit, the flight circle diameter can nevertheless be adjusted. This feature combination may also be advantageous, independently of the other features of the claimed invention, in other drill heads, particularly in those with a guide pad angle of more than 70°.

Radial settability can be achieved in that at least one of the guide pads is assigned a setting device for setting the radial spacing between its outer bearing zone and the axis of rotation.

In a development of the invention, the setting device is assigned to the second guide pad, preferably to only the second guide pad.

In a preferred refinement, the setting device has at least one locating plate. The use of locating plates affords the advantage that they are easily exchangeable and a defined variation in the spacing can be set especially easily. It is advantageous to use screwed guide pads, if appropriate according to the prior art, under which are placed locating plates, of which the length and width correspond to the associated guide pad and which are fastened together with the guide pad in a similar way to a shim. However, the guide pads and locating plates may also be fastened to the drill head body in another way.

In an alternative refinement, continuous setting of the radial spacing is possible. For this purpose, a preferred setting device has at least one setting wedge. However, the setting device may also be a screwing device or a combination of both. The use of setting wedges and/or of a screwing device has the advantage that the radial spacing can be set continuously, whereas, when locating plates are used, the spacing can be set in steps only according to the locating plate thickness. One or more setting wedges which are arranged correspondingly with respect to one another may be provided for a setting device. In a corresponding refinement of a guide pad groove or of the guide pad itself in wedge form, even only one wedge may be provided. It is also conceivable that the guide pad and the groove form two oppositely arranged wedges. However, an additional fixing device, for example by means of screws, should be provided, so that the guide pad can be fixed in its groove.

In a development of the invention, the drill head has a setting device for setting the guide pad angle, preferably for continuous setting. In this case, it is advantageous if the guide pad angle can be adjusted at least over an angular range of ±10° about a nominal guide pad angle. It is especially advantageous if a guide pad angle of 30° to 70° can be set continuously. The guide pad angle can thus be adapted for different drilling parameters, for example in each case such that the passive force acting radially upon the secondary cutting edge becomes approximately or completely zero or assumes another defined value. By means of the adjustable guide pad angle, the flexibility of use of the drill head for different materials with different drilling parameters is markedly increased. This means that the number of drill head variants to be kept in stock in a business in which the most diverse possible materials are processed can be reduced, thus markedly lessening the investment costs. It is conceivable that, for a range of adjustment of the guide pad angle, there be provided in the drill head a groove which is wider than the guide pad arranged in it and in which the guide pad can be fixed in the circumferential direction for the selected guide pad angle by means of the setting device. The setting device may in this case have at least one locating plate, at least one setting wedge and/or other setting means.

In a development of the invention, the drill head has a multipart cutting edge which is divided into a plurality of partial cutting edges, each with a part main cutting edge cant. Preferably, the cutting edge is in this case divided into two or three partial cutting edges, the partial cutting edges forming a common main cutting edge and being arranged such that the active regions of their part main cutting edges overlap in the radial direction, and their overall main cutting edge cant length is greater than half the drill head cutting edge diameter. If the overall main cutting edge cant length is smaller than half the drill head cutting edge diameter, full drilling cannot take place, since material cannot be removed over the entire borehole diameter. Deep hole drilling tools or deep hole drill heads for deep hole drilling with a divided cutting edge are especially advantageous in the case of larger borehole diameters. Even cutting edge inserts made from different cutting materials or cutting edge inserts coated with different cutting materials may be used. It is possible to select the cutting material as a function of the load upon the respective partial cutting edge.

This and further features may be gathered not only from the claims, but also from the description and the drawings, where the individual features can in each case be implemented separately or severally in the form of subcombinations in an embodiment of the invention and in other fields and can constitute advantageous and independently patentable versions.

### BRIEF DESCRIPTION OF THE DRAWINGS

Exemplary embodiments of the invention are illustrated diagrammatically in the drawings and are explained in more detail below. In the drawings:

FIG. 1 shows an embodiment of a drill head in a perspective illustration with a cutting edge divided in two,

FIG. 2 shows a view of the drilling side of a drill head from the prior art with a one-part cutting edge,

FIG. 3 shows a view of the drilling side of the drill head from FIG. 1,

FIG. 4 shows a view of the drilling side of a drill head in an alternative embodiment with a one-part cutting edge,

FIG. 5 shows a view of the drilling side of a drill head in another embodiment with a settable guide pad angle, and

FIG. 6 shows another perspective illustration of the drill head from FIG. 1 with a diagrammatic illustration of a detail of the outer region of the cutting edge.

### DETAILED DESCRIPTION OF THE PREFERRED EMBODIMENTS

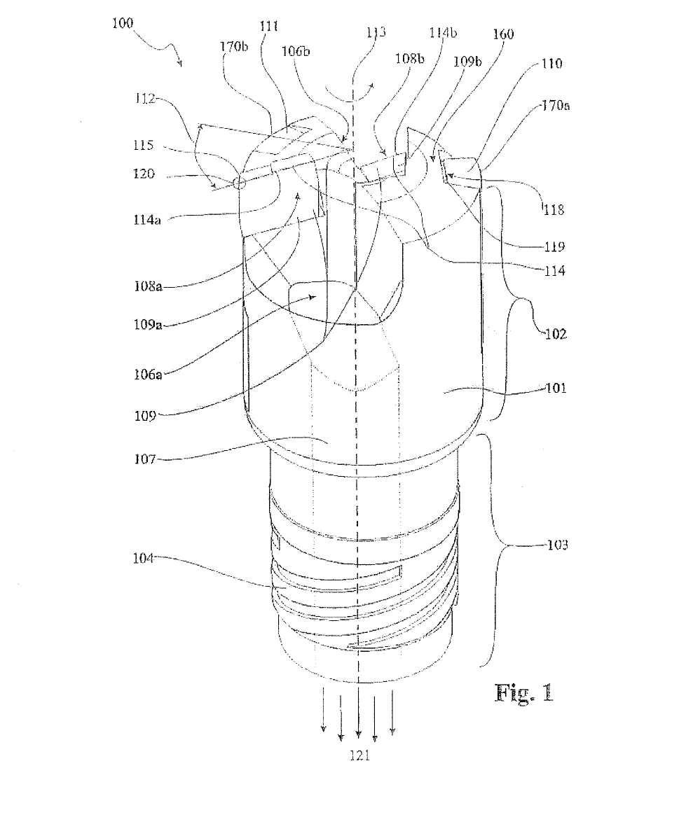

FIG. 1 illustrates in perspective illustration an exemplary embodiment of a drill head 100 with a cutting edge 109 divided into two partial cutting edges 109a and 109b. The drill head 100 shown has an essentially cylindrical drill head body 101 rotatable about an axis of rotation 113 and with a drilling region 102 and a shank region 103. The shank region 103 is designed to be connected to a drill tube, not illustrated here. For the exemplary embodiment shown, a special connecting thread 104 is provided for tying the drill head 100 to the drill tube. This may be a customary single-start or quadruple-start connecting thread for BTA drill heads. In the case of very small drilling diameters in the range of approximately 7 mm to 12 mm, the drill head may even be incorporated directly into the drill tube. With large deep hole drilling tools, the drill head may also be flanged on.

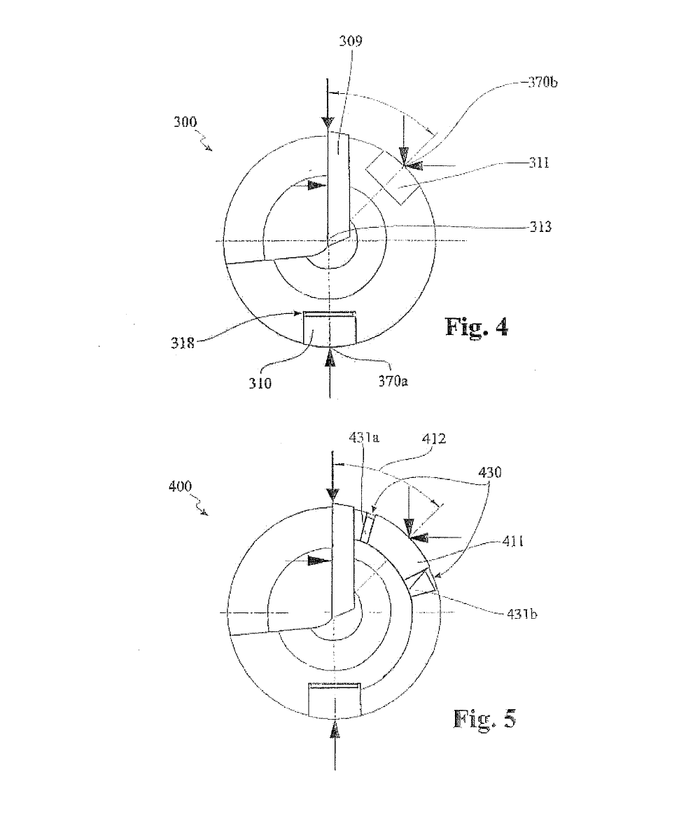

The cutting edge 109 with its two partial cutting edges 109a and 109b, which form respectively an outer cutting edge 109a and an inner cutting edge 109b, is arranged on a drilling side 160 of the drill head body 101. A drill head according to the invention may also have a plurality of cutting edges or a one-part cutting edge, as illustrated in FIGS. 4 and 5. The cutting edge may also be and divided into more than two partial cutting edges, for example into three partial cutting edges. However, as illustrated in FIGS. 1 to 6, it is characteristic of a deep hole drilling tool to have an asymmetric arrangement of the cutting edge 109 or of the partial cutting edges 109a and 109b with respect to the axis of rotation 113. In this case, during the drilling operation, forces, which will be explained in more detail later, acting asymmetrically upon the drill head 100 or upon the entire deep hole drilling tool arise.

During the drilling operation, material is detached from the workpiece to be machined by a cutting wedge on the main cutting edge 104 or its main cutting edge cants 114a and 114b and on the secondary cutting edge or its secondary cutting edge cant 115. The main cutting edge cant 114a and the secondary cutting edge cant 115 of the outer cutting edge 109a form a cutting edge corner 120 which projects radially outward beyond the drill head body 101. Furthermore, the main cutting edge cant 114a and the secondary cutting edge cant 115 of the outer cutting edge 109a span a rake 108a. The rake 108b of the inner cutting edge 109b is formed correspondingly. A chip is likewise generated by the cutting wedge of the inner cutting edge 109b. In the exemplary embodiment illustrated, the main cutting edge cant 114a of the outer cutting edge 109a runs in the radial direction essentially in a longitudinal mid-plane, running through the axis of rotation, of the drill head, as can be seen very clearly in FIG. 3. However, the main cutting edge cant 114a does not run at right angles to the axis of rotation in a radial plane, but instead obliquely in the axial direction from the outside inward in the feed direction with a lead angle.

Furthermore, the embodiment illustrated in FIG. 1 has a chip collecting orifice 106a, arranged contiguously to the rake 108a of the outer cutting edge 109a, and a chip collecting orifice 106b, contiguous to the rake 108b. A cavity duct 107 for chip and cooling lubricant return, which runs inside the drill head 100 or inside the drill head body 101 from the drilling side 160 through the shank region 103, can be seen clearly. The chips generated by the respective partial cutting edges are discharged by the cutting wedge, in that they slide off over the respective rake 108a or over the rake 108b into the respectively associated chip collecting orifice 106a or 106b and are conducted from there, together with cooling lubricant washing around the drill head 100, into the cavity duct 107.

At the outlet of the drill head 100, this chip/cooling lubricant mixture 121 is conducted further on into a connected drill tube, not illustrated here, as far as an outlet orifice. It is important that a blockage-free return of the chips and of the cooling lubricant is ensured.

The drill head 100 shown in this figure is basically suitable both for BTA deep hole drilling and for ejector deep hole drilling. It merely has to be ensured that the drill head can be connected to the correspondingly designed drill tube, and that a supply of cooling lubricant is ensured correspondingly.

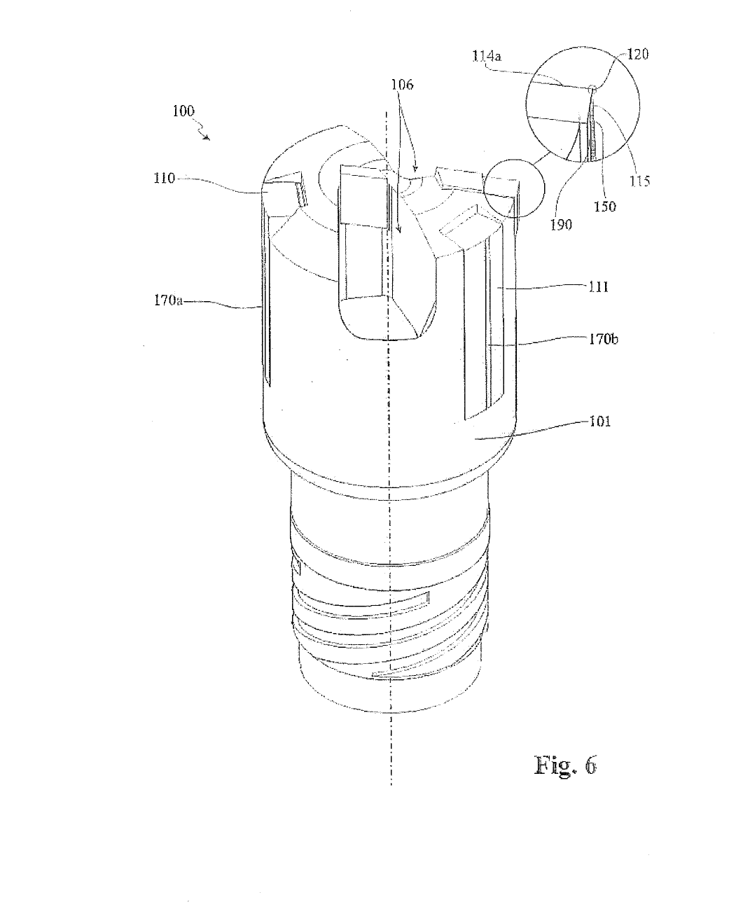

The guide pads 110 and 111 have in each case an outer bearing zone or contact zone 170a and 170b which can be seen clearly in FIG. 6. These bearing zones 170a and 170b are in each case provided for bearing against the inner wall of the borehole and are designed for this purpose. In this case, it is especially advantageous if the guide pads 110 and 111 are ground especially in order to minimize a frictional force between the guide pads 110 and 111 and the inner wall of the borehole.

For guidance in the borehole, the outer cutting edge 109a, which forms a first bearing region with its cutting edge corner 120, is provided in addition to the guide pads 110 and 111 with their outer bearing zones 170a and 170b. In this case, in the exemplary embodiment shown, one of the guide pads is arranged exactly diametrically opposite the cutting edge corner 120, that is to say at an angle of 180° to the cutting edge corner 120. This guide pad is designated as the second guide pad 110 and supports the forces acting essentially radially upon the cutting edge 109, see FIG. 3. The other guide pad 111 is designated as the first guide pad and supports, on the one hand, tangentially acting forces and, on the other hand, radial forces and thus relieves the secondary cutting edge, see likewise FIG. 3. The first guide pad 111 is in this case arranged in a circumferential half, facing away from the rake 108a of the outer cutting edge 109a, of the drill head body 101 or of the drill head 100, in order, inter alia, to support the cutting force 113 acting tangentially upon the outer cutting edge 109a.

It can be seen clearly in this figure how the guide pad angle 112 is defined. It is formed by a first straight line running radially through the cutting edge corner 120 and the axis of rotation 113 and by a second straight line likewise running radially through the axis of rotation 113. In this case, the second straight line runs orthogonally to a tangent which has its contact point at the theoretical bearing point of the outer bearing zone 170 of the first guide pad 111 against the inner wall of the borehole. The straight lines lie in this case in a plane perpendicular to the axis of rotation 113, the cutting edge corner 120 likewise lying in this plane. The apex of the guide pad angle 112 is obtained from the intersection point of the two straight lines and lies on the axis of rotation 113.

In this exemplary embodiment, the first guide pad 111 is arranged so as to be offset to the cutting edge corner 120 by the amount of a guide pad angle 112 of approximately 45°. However, the guide pad angle 112 may also be 30° or 70° or lie between these, although it should not lie above 70°. It is dependent essentially on the cutting edge geometry and its arrangement and on the material to be machined which critically determines the required drilling parameters.

To vary the radial spacing of the outer bearing zone 170a of the second guide pad 110 from the axis of rotation 113, the drill head 100 has a setting device 118. The setting device 118 has a locating plate 119, although, to vary the radial spacing of the outer bearing zone 170a, a plurality of locating plates 119 or locating plates of different thickness may also be arranged one above the other beneath the guide pad 110. It is also conceivable to use setting wedges instead of locating plates. Advantageously, in this case, two setting wedges are arranged opposite one another, cf., in this regard, component 431b in FIG. 5. The radial spacing can then be set continuously by pushing the two wedges together or apart from one another. However, the setting device 118 may also be provided for the first guide pad 111 or for both guide pads 110 and 111 and/or for other supporting and/or auxiliary strips. It is preferably provided for only the second guide pad 110.

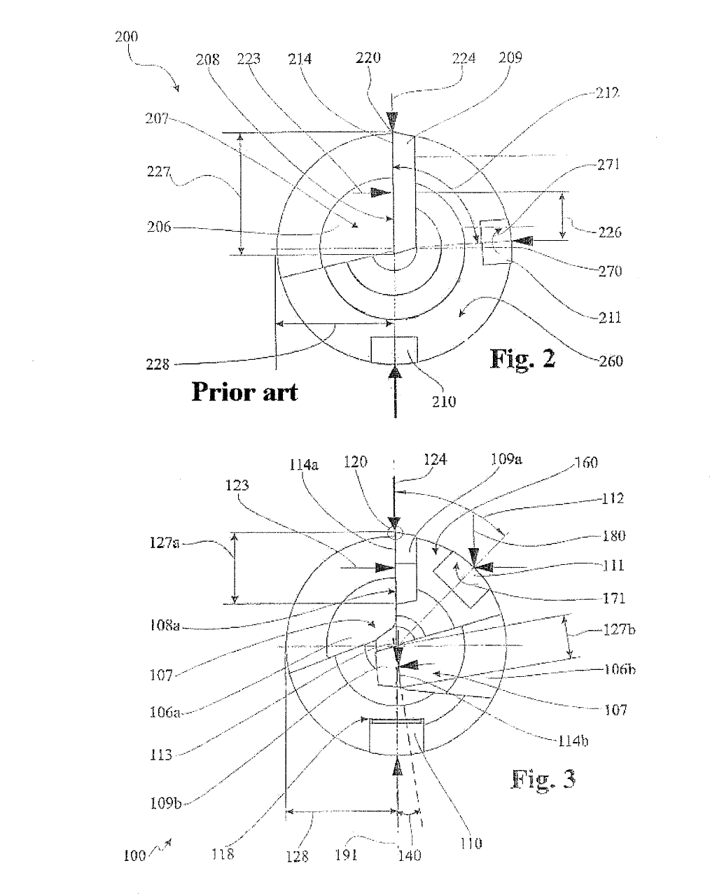

FIG. 2 illustrates, for better understanding, a BTA deep hole drill head 200 from the prior art in a view from the drilling side with a one-part cutting edge 209. This illustration makes it possible to comprehend clearly the problem of BTA deep hole drill heads known from the prior art with regard to the load occurring on the secondary cutting edge and to the resulting wear on the secondary cutting edge and correspondingly reduced tool lives. The figure shows the cutting force 223 perpendicular to the rake 208 and acting upon the main cutting edge cant 214 and also the arrangement of the guide pads 210 and 211 in relation to the cutting edge 209 or the cutting edge corner 220. The first guide pad 211 is arranged, offset to the cutting edge corner 220 by the amount of a guide pad angle 212 of approximately 88°, in a circumferential half of the drill head 200 which faces away from the rake 208. The second guide pad 210 is arranged exactly diametrically opposite the cutting edge corner 220. Chip discharge takes place via a chip collecting orifice 206 and from there into the cavity duct 207. Since only one undivided cutting edge 209 is provided, only one chip collecting orifice 206 is also required. Furthermore, the figure shows an overall main cutting edge cant length 227 which is greater than a borehole nominal radius 228, this being necessary in order to remove material over the entire borehole diameter and not leave any core standing. What can be seen clearly in this illustration is an effective lever arm 226, by means of which the cutting force 223 generates a tilting moment 271 about the bearing zone 270 of the first guide pad 211. This gives rise to a supporting force or passive force 224 at the secondary cutting edge or cutting edge corner 220.

FIG. 3 illustrates a view of the drilling side 160 of the drill head 100 from FIG. 1. It can be seen clearly in this illustration that, with the first guide pad 111 being arranged at a guide pad angle 112 to the cutting edge corner 120 of less than 70°, for example about 45°, an effective lever arm for a corresponding resultant cutting force 123 can, depending on the selected drilling parameters, be reduced markedly, as compared with the prior art, see FIG. 2. This means that, by the choice of a corresponding guide pad angle 112 as a function of the forces acting during the drilling operation, a passive force 124 acting radially upon the secondary cutting edge, not illustrated clearly here, can be set to virtually zero. The supporting force is thus distributed essentially to the two guide pads 110 and 111. In this case, the first guide pad 111 absorbs both tangentially acting forces, such as, for example, the cutting force 123, and radially acting forces with respect to the secondary cutting edge, as illustrated here by the force 180. If the selected guide pad angle 112 is still smaller, even a counterclockwise tilting moment may be generated, depending on the forces acting during the drilling process.

It can be seen in this illustration that the inner cutting edge 109b has an inner main cutting edge cant 114b oriented so as to be rotated by an angle 140 with respect to the diametral line 191. However, the inner main cutting edge cant 114b may also be oriented along the diametral line 191. Orienting the inner main cutting edge cant 114b obliquely with respect to the diametral line 191 may be beneficial for influencing the guide pad load. The outer main cutting edge cant 114a and the inner main cutting edge cant 114b together form, from the sum of their individual lengths 127a and 127b, the overall main cutting edge cant length which should likewise be greater than the borehole nominal radius 128. Furthermore, in each case the two chip collecting orifices 106a and 106b which both lead into a common cavity duct 107 can also be seen clearly in FIG. 3. The embodiment shown in this figure likewise has a setting device 118 for varying the radial spacing of the outer bearing zone 170 of the guide pad 110 from the axis of rotation 113.

FIG. 4 illustrates an alternative exemplary embodiment of a drill head 300 in a view of the drilling side. In contrast to the exemplary embodiment shown in FIG. 1, this drill head 300 has a one-part cutting edge 309. The embodiment shown likewise has a setting device 318 for varying the radial spacing of the outer bearing zone 370a of the second guide pad 310 from the axis of rotation 313.

FIG. 5 shows a further embodiment of a drill head 400 in a view of the drilling side. In this embodiment, the guide pad angle 412 of the first guide pad 411 can be set, preferably continuously, at least over a defined angular range. This is achieved by means of a setting device 430. This setting device may have as setting means a locating plate 431a and/or setting wedges 431b. Setting wedges 431b are suitable especially for continuous adjustment of the guide pad angle 412. The setting means illustrated may also be combined or only one wedge may be provided. It is also conceivable to arrange the first guide pad 411 on a sliding rail which is arranged and acts in the circumferential direction and on which the first guide pad 411 is guided and can be fixed by means of a screw or the like with a defined guide pad angle 412. It is important in this case that the first guide pad 411 is fixed and positioned during the drilling operation such that it can reliably support the acting forces and is not displaced or rotated or the like. It is especially advantageous if the first guide pad 411 can be adjusted in the circumferential direction by the amount of approximately ±10°, if possible even more, so that even guide pad angles 412 of 35° to 55°, in particular guide pad angles 412 of 30° to 70°, can be set continuously by means of the same drill head 400 having a nominal guide pad angle 412 of 452.

In a similar way to the type of action, illustrated diagrammatically here, of the wedges, by means of which continuous angular adjustment is possible, the wedges may also be used, also according to this principle, as setting means for varying the radial spacing of the outer bearing zone of the guide pad 410.

FIG. 6 illustrates the drill head 100 from FIG. 1 in perspective from another direction, with a detailed illustration of the cutting edge corner 120. The figure shows the arrangement of the guide pads 110 and 111 parallel to the axis of rotation 113 on the outside of the drill head body 101. In the illustration of the detail, the cutting edge corner 120 can be seen clearly, which is formed by the main cutting edge cant 114a and the secondary cutting edge cant 115 of the outer cutting edge 109a. Contiguous to the secondary cutting edge cant 115 is a region 150 which, in the case of the BTA drill heads known from the prior art, is normally ground in the form of a circular-ground chamfer which has a ground radius in a similar way to the outer bearing zones 170 and 370 of the guide pads 110, 111.

In the drill head 100 illustrated, however, there is no circular-ground chamfer provided in this region 150. In an appropriate configuration of the drill head, the circular-ground chamfer may also be omitted for other embodiments than in the exemplary embodiments shown here.

The embodiments shown have only two guide pads, although further guide pads or other supporting and/or auxiliary strips may be provided. Preferably, for oscillation damping, a further guide pad is arranged axially parallel in the circumferential direction in about the same radial position as the cutting edge corner, but behind the cutting edge in the feed direction.

1. A drill head for a deep hole drilling tool for BTA/STS or ejector deep hole drilling, comprising:
a drill head body which is rotatable about an axis of rotation and which has a drilling side and, inside, a cavity duct for chip and cooling lubricant return with at least one chip collecting orifice on the drilling side;
a cutting edge, which is arranged on the drilling side and which has a main cutting edge with a main cutting edge cant and a secondary cutting edge with a secondary cutting edge cant, the secondary cutting edge being arranged on a radial outside of the cutting edge, and the main cutting edge cant and the secondary cutting edge cant forming a cutting edge corner and spanning a rake which is arranged contiguously to the chip collecting orifice; and
guide pads, a first guide pad being arranged, offset to the cutting edge corner by an amount of a guide pad angle measured in a circumferential direction of the drill head, in a circumferential half, facing away from the rake, of the drill head body, and a second guide pad being arranged diametrically opposite the cutting edge corner,
wherein the guide pad angle amounts to less than 70°.

2. The drill head as claimed in claim 1, wherein the guide pad angle amounts to 30° to 70°.

3. The drill head as claimed in claim 1, wherein, for defined drilling parameters, the guide pad angle is selected such that, in the case of a cutting force acting perpendicularly upon the rake on the main cutting edge cant during the drilling process, a passive force acting upon the secondary cutting edge in the radial direction becomes approximately zero.

4. The drill head as claimed in claim 1, wherein the secondary cutting edge has no circular-ground chamfer.

5. The drill head as claimed in claim 1, wherein the cutting edge is arranged in a firm fit.

6. The drill head as claimed in claim 1, wherein at least one of the guide pads is assigned a setting device for setting a radial spacing between its outer bearing zone and the axis of rotation.

7. The drill head as claimed in claim 6, wherein the setting device is assigned to the second guide pad.

8. The drill head as claimed in claim 6, wherein the setting device has at least one locating plate.

9. The drill head as claimed in claim 6, wherein the setting device is designed for continuous setting of the radial spacing, the setting device having at least one setting wedge.

10. The drill head as claimed in claim 1, wherein the drill head has a setting device for setting the guide pad angle.

11. The drill head as claimed in claim 1, wherein the cutting edge is divided into a plurality of partial cutting edges, each with a part main cutting edge cant, the part main cutting edge cants forming a common main cutting edge cant and being arranged such that active regions of their part main cutting edge cants overlap in the radial direction and their overall main cutting edge cant length is greater than half the drill head nominal diameter.

12. A deep hole drilling tool for BTA deep hole drilling, in particular for ejector deep hole drilling, wherein the deep hole drilling tool has a drill head as claimed in one of claim 1.

13. The drill head as claimed in claim 2, wherein the guide pad angle amounts to 40° to 60°.

14. The drill head as claimed in claim 7, wherein only the second guide pad is assigned a setting device.

15. The drill head as claimed in claim 9, wherein the setting device continuously sets the guide pad angle.

16. The drill head as claimed in claim 11, wherein the cutting edge is divided into two or three partial cutting edges.
